(19) United States
(12) Patent Application Publication
(10) Pub. No.: US 2024/0055601 A1
(43) Pub. Date: Feb. 15, 2024

(54) Electrochemical cells based on intercalation and deintercalation of chalcogen anions

(71) Applicants: Centre national de la recherche scientifique, PARIS (FR); Nantes Université, NANTES (FR)

(72) Inventors: Laurent CARIO, NANTES (FR); Shunsuke SASAKI, NORTH OXFORD (GB); Stéphane JOBIC, BOUGUENAIS (FR); Maria Teresa CALDES, NANTES (FR); Etienne JANOD, LA CHAPELLE SUR ERDRE (FR); Benoît CORRAZE, NANTES (FR); Isabelle BRAEMS-ABBASPOUR, NANTES (FR); Louis-Béni MVELE, NANTES (FR); Catherine DEUDON, NANTES (FR)

(21) Appl. No.: 18/259,259

(22) PCT Filed: Dec. 24, 2021
(86) PCT No.: PCT/EP2021/087650

§ 371 Date: Jun. 23, 2023

(30) Foreign Application Priority Data
Dec. 24, 2020 (FR) FR2014131

(51) Int. Cl. H01M 4/58; H01M 4/04; H01M 4/66; H01M 10/0565; H01M 4/02

(52) U.S. Cl. CPC H01M 4/5815; H01M 4/0404; H01M 4/661; H01M 10/0565; H01M 2004/021; H01M 2300/0082; H01M 2004/028

(57) ABSTRACT

An electroactive material suitable for electrochemical cell electrode wherein the electroactive material includes a chalcogen oligomer that can reversibly deintercalate/reintercalate an anion of the chalcogen, such as La₂O₂S₂, and the electrochemical electrodes and cells containing the electroactive material.

### CROSS-REFERENCE TO RELATED APPLICATIONS

This application claims benefit under 35 USC § 371 of PCT Application No. PCT/EP2021/087650 entitled ELECTROCHEMICAL CELLS BASED ON INTERCALATION AND DEINTERCALATION FO CHALCOGEN ANIONS, filed on Dec. 24, 2021 by inventors Laurent Cario, Shunsuke Sasaki, Stéphane Jobic, Maria Teresa Caldes, Etienne Janod, Benoît Corraze, Isabelle Braems-Abbaspour, Louis Béni Mvele and Catherine Deudon. PCT Application No. PCT/EP2021/087650 claims priority of French Patent Application No. 20 14131, filed on Dec. 24, 2020.

### FIELD OF THE INVENTION

The present invention concerns the field of electrochemistry, and solid ion batteries in particular.

### BACKGROUND OF THE INVENTION

In view of the global warning and the shortage of natural ressources, the production and storage of renewable energy are crucial and represent one of the major challenges for the scientific community.

Electric devices and electric transportation are nowadays based on lithium batteries. However, the lithium resources are limited. Therefore, researchers already consider alternative batteries with sodium for example.

In these batteries, the alcaline metal cation (Li+, Na+) ensures the conduction within the electrolyte: the cation (eg. Li⁺ ion) is exchanged between two active materials located on the positive and the negative electrodes. These materials can intercalate and deintercalate lithium, at least in the positive electrode.

More recently, Li-ion batteries using elementar sulfur as a cathode have been considered (Manthiram et al. chem. Rev. 2014, 114, 11751-11787). However, in such lithium-sulfur batteries, the conducting ionic species which moves between the sulfur cathode and the lithium anode is still the lithium cation (Li⁺).

Alternative ionic species were also studied as conducting species in the electrochemical cells, for example, zinc-ion batteries which include zinc at the negative electrode and manganese oxide at the positive electrode. These electrochemical systems are extensively studied but their interest is still questioned: after years of researches, the first stable charge/discharge cycle has been recently achieved for a battery using aluminium ions as the intercalated species. Magnesium ions batteries have been successfully achieved. Still, the use of alternative cations remains a challenge.

Batteries based on the intercalation or deintercalation of an anion have been substantially less investigated. Most of the researches focus on metal ions where O²⁻ ions migrate from a air cathode towards a metal anode during the discharge. Organic anions have also been considered (PF₆_{^{−}}, BF₄_{^{−}}, TFSI). Alternative anion batteries use fluoride, chloride and metal halogenide such as BiF₃ and BiCl₃ as a cathode and reactive metals such as lithium as an anode, so that the halogenide anions migrate from the cathode to the anode.

However, sources in lithium are limited and alternative materials need to be considered.

### SUMMARY OF THE DESCRIPTION

Therefore, it is an object of the invention to provide alternative electroactive materials that rely on naturally abundant elements, such as chalcogens.

The present inventors have discovered that it is possible to deintercalate and re-intercalate at moderate temperature (<300° C.) chalcogen/chalcogenide, such as sulfur, from materials containing chalcogen oligomers, such as sulfur pairs.

This phenomenon has been proved to be reversible. This discovery allows to consider the use of such chacolgen materials to provide chalcogen-chalcogen, e.g. sulfur-sulfur, batteries. Such batteries involve active materials comprising chalcogen oligomers, such as chalcogen pairs, and the exchange of a chalcogen anion between the cathode and the anode.

Therefore, according to a first object, the present invention concerns an electroactive material for electrochemical cell electrode wherein said material comprises a chalcogen oligomer, characterized in that said material can reversibly deintercalate an anion of said chacolgen by reduction and reintercalate said anion by oxidation, while maintaining its overall structure.

The term «electroactive material» as used herein refers to materials that can be used as an electrode material and that can undergo an oxydo-reduction reaction.

Chalcogens are the chemical elements in group 16 of the periodic table. This group comprises in particular the following elements: oxygen (O), sulfur (S), selenium (Se), tellurium (Te). Typically, the chalcogen is sulfur.

The term “oligomer” denotes a neutral or charged chemical species comprising chalcogen atoms chemically linked to each other via strong chemical bonds. Typically, these blocks consist of a few identical chalcogen atoms, typically between 2 and 6, with a charge that can range from 1 to 2. Chalcogen oligomer thus represents alinear or non linear sequence of 2 to 6 chalcogen atoms, typically of formula Qₙ, where Q represents a chalcogen atom and n represents an integer comprised between 2 and 6. Typically, the chalcogen oligomer is a sulfur pair (S—S).

Typically, said material comprising a chalcogen oligomer may be chosen in particular from La₂O₂S₂, SrS₂, SrS₃, BaS₂, BaS₃, Ba₂S₂F₂, FeS₂, NiS₂, CoS₂, MnS₂, TiS₃, VS₄, PbS₂, BiS₂ but any compound with a sequence of at least 2 chalcogen atoms can be of interest

According to the invention, said materials comprise chalcogen oligomers that can be reduced to form chalcogen anions or chalcogen oligomers anions, such as:

(Qₙ)²⁻(2n-2)e⁻→n Q²⁻

In the case where chalcogen is sulfur, the following reductive cleavage can take place: (S₂)²⁻+2e⁻→2 S²⁻ or (S₃)²⁻+4e⁻→3 S²⁻

As an illustration, La₂O₂S₂ structure consists of fluorite-type 2/∞[La₂O₂]²⁺ infinite layers separated from each other by isolated (S₂)²⁻ sulfur dimers aligned in parallel to these 2D blocks. The de-insertion (ie) deintercalation of one sulfur atom per dimer leads to a La₂O₂S compound whose structure is inherited from the layered structure of the precursor La₂O₂S₂. This very new phase crystallizes in the Amm2 space group and is a new polymorph of the well known hexagonal La2O2S (hp-La2O2S (P-3m1)). Hereafter, the oA-La2O2S term will be used for this specific orthorhombic form in contrast with the well-known hexagonal form.

Accordingly, La₂O₂S₂ reversibly deintercalates and reintercalates S²⁻ according to the following reaction:

La₂O₂S₂+2e⁻⇄oA-La₂O₂S+S²⁻
where oA designates the centered orthorhombic crystalline form.
oA-La₂O₂S has never been synthesized or identified before.

According to another object, the present invention thus also concerns the material of formula:

oA-La₂O₂S (I)
where oA designates the centered orthorhombic crystalline form.

Similarly, La₂O₂S₂ also reversibly deintercalates and reintercalates 0.5 S⁻ according to the following reaction:

La₂O₂S₂+e⁻⇄oA-La₂O₂S_{1.5}+0.5S²⁻

oA-La₂O₂S_{1.5} (Amm2 space group) has never been synthesized or identified before.

According to another object, the present invention thus also concerns the material of formula (II):

oA-La₂O₂S_{1.5} (II)
where oA designates the centered orthorhombic crystalline form.

According to an embodiment, oA-La2O2S (I) can be prepared by a process comprising the steps of mixing La₂O₂S₂ and Rb and heating said mixture. Typically, the reaction can be conducted in sealed silica tube, preferably in 1: 2 molar ratio. Typically the heating temperature is comprised between 200 and 350° C., in particular by application or adaptation of the procedure discussed in the examples.

According to an embodiment, oA-La₄O₄S₃(II) can be prepared in a similar way. According to an alternative embodiment, it can also be prepared by intercalation of sulfur anions into oA-La₂O₂S (ie) by a process comprising the steps of mixing oA-La₂O₂S with S flakes, and heating said mixture. Typically, the mixture can be pelletized and sealed in an evacuated silica tube before the heating step. Typically, the heating temperature is comprised between 150 and 200° C.

Materials of formula (I) and (II) can be characterized by their X-ray and electron diffraction spectrum, as illustrated in the attached Figures.

As used herein, deintercalation refers to the de-insertion of an atom or ion from a host lattice where it has been residing, whereas reintercalation refers to the reinclusion (or reinsertion) into the lattice, in a reversible fashion and without modification of the overall crystal structure of the host material (ie) its lamellar structure.

According to the invention, a chalcogen (or chalcogenide) anion (typically S²⁻) deintercalates from the electrode material during discharge (reduction) and reintercalates within said material during charge (oxidation), at the positive electrode.

According to an embodiment, said chalcogen anion is sulfur or an oligomer thereof of formula (III):

(Sₙ)^{x-} (III)
where n and x are integers, such that x equals to 1 or 2, and n is comprised between 1 and 6.
   Typically, n is 1 and x is 2, so that said chalcogen anion is S²⁻.

According to an embodiment, the electrochemical cell electrode is a positive electrode. The positive electrode refers to the electrode of an electrochemical cell herein referred to as element, where electrons enter, and where chalcogen ions leave in discharge.

The “positive electrode” designates in discharge, the electrode functioning as a cathode and in charge, the electrode functioning as an anode, the anode being defined as the electrode where an electrochemical oxidation reaction (emission of electrons), while the cathode is the seat of reduction.

According to another object, the present invention also concerns a positive electrode comprising the electroactive material of the invention.

According to an embodiment, the positive electrode may comprise a current collector and a coating layer, wherein said coating layer comprises said electroactive material.

The positive electrode generally consists of a conductive medium used as a current collector which is coated with a mixture comprising the electroactive material, and, typically solid-state electrolyte particles, an electrically conductive additive and a binder.

The term “current collector” is understood to mean an element such as a pad, plate, foil, sheet, mesh, tissue or other, made of a conductive material, connected to the positive or negative electrode, and ensuring the conduction of the flow of electrons between the electrode and the terminals of the battery

Typically, the current collector consists in a metal or alloy chosen from the group consisting in aluminium, copper, nickel, carbon, stainless steel, and the alloys thereof.

According to an embodiment, the current collector is an aluminium sheet.

According to another object, the present invention also concerns an electrochemical cell comprising:
A positive electrode as defined above;
A negative électrode;
An electrolyte layer sandwiched between the positive and the negative electrodes, characterized in that the electrolyte is a solid electrolyte comprising as conducting ion the chalcogen anion of the chalcogen oligomer of the electroactive material.

The term “negative electrode” designates in discharge, the electrode functioning as an anode and in charge, the electrode functioning as cathode, the anode being defined as the electrode where an electrochemical oxidation reaction (emission of electrons) occurs, while the cathode is the seat of reduction.

Typically, the term negative electrode refers to the electrode from which electrons leave, and on which chalcogen anions are collected in discharge

By “electrochemical cell” is meant an elementary electrochemical cell made up of the positive electrode/electrolyte/negative electrode assembly, allowing the electrical energy supplied by a chemical reaction to be stored and returned in the form of current.

According to an embodiment, the electrochemical cell is a solid-state cell.

In all-solid-type elements, the electrolytic compounds can be included in the solid-state electrolyte layer, but can also be partially included within the electrodes.

According to another object, the present invention concerns a battery comprising a plurality of electrochemical cells as defined above, wherein the cells are electrically connected.

By “battery” or accumulator is meant the assembly of several cells according to the invention.

### BRIEF DESCRIPTION OF THE DRAWINGS

FIG. 1 illustrates the principle of a sulfur-sulfur battery according to the invention, involving sulfur as the chacolgen and La₂O₂S₂ as the electroactive material.

FIG. 2 illustrates (a) Structure of La₂O₂S₂ reported by Ostorero et al. (SG: Cmca) (Acta Cryst. C46, 1376-1378 (1990)); (b) Conceptual scheme of S—S bond cleavage under the donation of one electron per elemental metal M⁰ that triggers subsequently the deintercalation of half sulfur atom of the S₂ dumbbell that possibly enables topochemical conversion of La₂O₂S₂ into the new polymorph of La₂O₂S; (c) The two low-energy dynamically stable phases of oA-La₂O₂S predicted by USPEX.

FIG. 3 illustrates (a) the partial intercalation of sulfur into oA-La₂O₂S and de-intercalation of sulfur from La₂O₂S₂ that leads to an intermediate compound oA-La₂O₂S_{1.5}; (b) intercalation experiments of sulphur into oA-La₂O₂S. Experimental XRD patterns of pure oA-La₂O₂S and the products of its mixture with sulfur (0.5 or 1 equiv. of S) after thermal treatments at 150 or 200° C. The new XRD peaks emerging after the thermal treatment with 0.5 S are marked by*; (c) Deinterciation of sulphur from La₂O₂S₂. Experimental XRD patterns of La₂O₂S₂ and of the product of its mixture with Rb⁰, Ag⁰ and Ni⁰ after the thermal treatments at 200 or 350° C. The XRD peaks assigned to by-products are marked as follows: •=Ag₂S (Für Krist.-Cryst. Mater. 110, 136-144 (1958); ▪=α-NiS (J. Trahan, R. G. Goodrich, S. F. Watkins, Phys. Rev. B 2, 2859-2863 (1970)).

FIG. 4 represents the overview of the rich low temperature sulfur topochemistry in the La—O—S system. The topochemical intercalation and deintercalation of sulfur in the oxychalcogenide compound La₂O₂S₂ lead to the formation of two new metastable compounds.

FIG. 5 represents (a) EDX spectrum of the oA-La₂O₂S powder sample impregnated with the epoxy resin and (b) its backscattered electron image (BEI) as well as its elemental composition mapped for La and S.

### DETAILED DESCRIPTION OF EMBODIMENTS

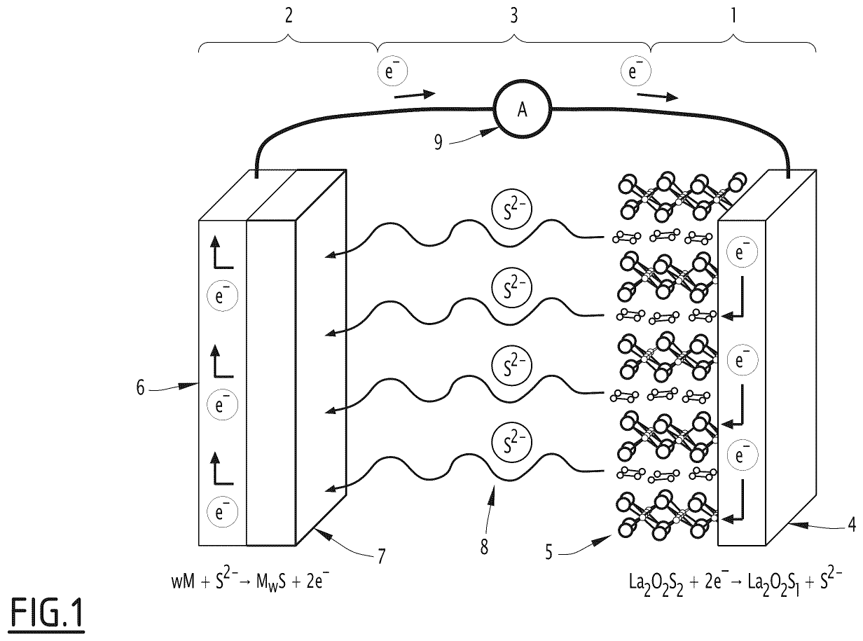

In FIG. 1, the cell of such a sulfur-sulfur battery is schematically represented during discharge.

Said cell comprises a positive electrode 1 (cathode), and a negative electrode 2 (anode). A sulfur anion conducting electrolyte 3 is sandwiched between electrodes land 2.

Both electrodes 1 and 2 are electrically connected by means of an electrical circuit including an ammeter 9.

As depicted in FIG. 1:

The positive electrode 1 comprises a current collector 4 and a layer of electroactive material 5. The layer 5 is at the interface between the conducting electrolyte 3 and the inner face of the current collector 4. Typically, the current collector 4 may be an aluminum sheet.

The negative electrode 2 comprises a current collector 6 and a layer 7 at the interface between the conducting electrolyte 3 and the inner face of the current collector 6.

Generally, the current collector 6 of the negative electrode is made of copper.

The layer 7 can consist of a sulfur composite or metal M which can react with sulfur anion according to the reaction: wM+S²⁻→M_{w}S+2e⁻. It can also consist of another material capable of intercalating and deintercalating sulfur anions.

During a discharge, the positive electrode 1 attracts electrons from the electrical circuit so that a reductive cleavage occurs, such as in the case of La₂O₂S₂:

La₂O₂S₂+2e⁻⇄oA-La₂O₂S+S²⁻

The S²⁻ anion migrate through the electrolyte 8 from the positive electrode 1 towards the negative electrode 2 and are collected at the negative electrode 2 to undergo an oxidation, releasing electrons: S²⁻, S⁰+2 e⁻ or wM+S²⁻M_{w}S+2e⁻

The resulting electrons are then migrating back to the positive electrode 1 through the electrical circuit 9.

Although not represented in FIG. 1, the opposite reactions occur in charge, where the positive electrode becomes the anode (set of the oxidation) and the negative electrode becomes the cathode (seat of the reduction).

The following examples are given for illustrative purposes only.

### Examples

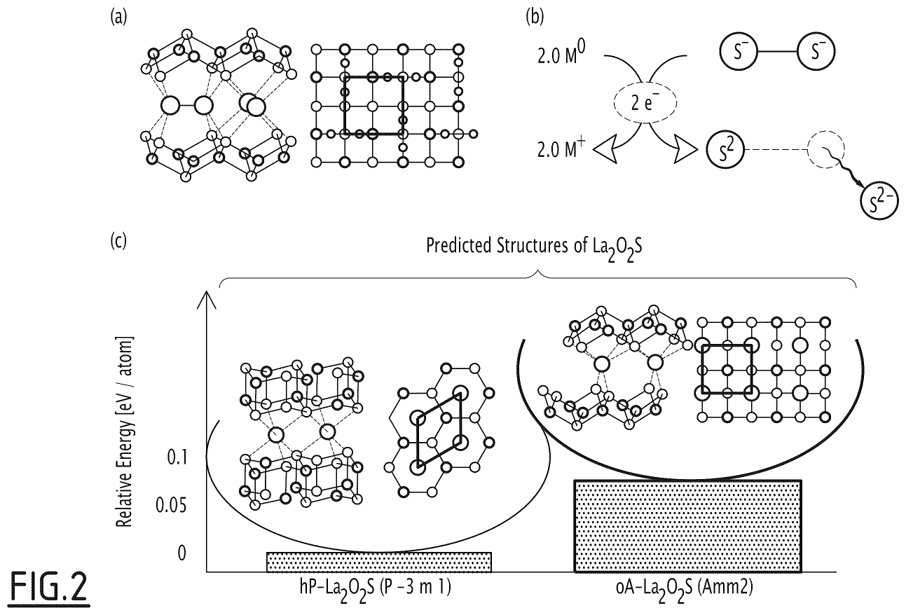

La₂O₂S₂ was used as the precursor to test the topochemical reduction for chalcogenides (FIG. 2a). Its structure consists of fluorite-type 2/∞[La₂O₂]²⁺ infinite layers separated from each other by isolated (S₂)²⁻ sulfur dimers aligned in parallel to these 2D blocks. The de-insertion of one sulfur atom per dimer should lead a priori to a La₂O₂S compound (FIG. 2b) whose structure should be inherited from the layered structure of the precursor La₂O₂S₂. First, the low-energy structures of La₂O₂S compound using a designed crystal structure prediction (CSP) methodology was investigated. The combination of USPEX structure searching evolutionary algorithm with first-principles calculations makes it possible to locate two polymorphs, namely hP and oA crystal structures that are respectively stable and metastable (see FIG. 2c). Both phases are dynamically stable, justifying their respective location at global and local minima on the potential energy surface of La₂O₂S. The most stable candidate exhibits a hexagonal layered structure with 2/∞[La₂O₂]fluorite-type (111) slab alternating with sulfur atoms in octahedral environment of lanthanum. Interestingly, this is the exact structure of the La₂O₂S compound reported in the literature (Acta Cryst. B29, 2647-2648 (1973)), commonly prepared at high temperature (800-1200° C.). In the following this structure will be noted hP-La₂O₂S according to the Pearson notation (h for hexagonal and P for primitive cell). USPEX predicted also the structure of a unknown metastable polymorph with an enthalpy only slightly higher. This structure displays also a layered feature but is built upon the stacking of 2/∞[La₂O₂] fluorine-type (001) slabs (full reminiscence of the La₂O₂S₂ structure) alternating with sulfur atoms in prismatic environments. In the same way with hP-La₂O₂S, this metastable polymorph with orthorhombic Amm2 space group is named hereafter oA-La₂O₂S. The thermal and kinetic stability of these two structures were further confirmed by ab initio molecular dynamics (AIMD) simulation in which both hP- and oA-La₂O₂S retained their main structural framework after 10 ps at temperatures up to 600 K. Consequently, the theoretical calculations clearly anticipate the possible existence of metastable oA-La₂O₂S besides the already known phase hP-La₂O₂S.

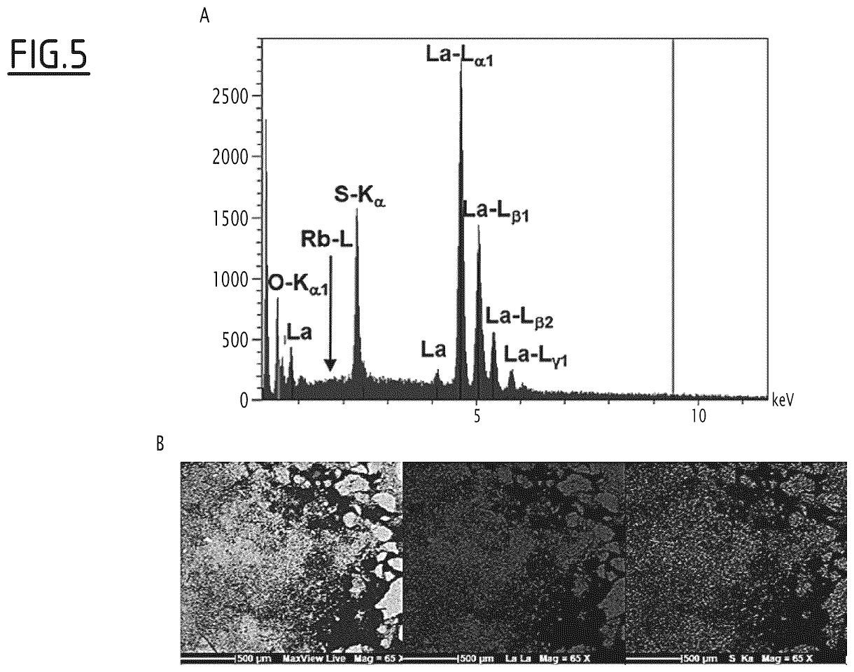

The topochemical deinsertion of sulfur in the layered precursor La₂O₂S₂ was subsequently attempted by reaction with alkali metal Rb⁰ at low-temperature in evacuated and sealed pyrex tubes. Once Rb excess (and its salts) was washed out by dry ethanol (see synthetic procedure in SI), the powder X-ray diffraction (XRD) patterns were collected on products synthesised at 200° C. and 350° C. Both of them turn out to be very similar and did not bring to light any known phases. Moreover, the EDX analyses of the bulk product powder clearly revealed the absence of rubidium and a molar ratio La/S of 2.0(2)/1.0(1) (See FIG. 5). These results indicate the formation of a sulfur-deficient La₂O₂S phase without incorporation of Rb in the structure. The hP-La₂O₂S XRD peaks were not detected at all in the X-ray pattern but the existence of the polymorph oA-La₂O₂S predicted by USPEX could be readily established via a Rietveld refinement with goodness of fit X²=1.33 and Bragg reliability factor R(obs)=1.67%: see Table below:

TABLE 1
Crystallographic parameters determined from Rietveld refinement of oA-
La₂O₂S powder.

| | |
|---|---|
| Crystallographic data | |
| Chemical formula | La₂O₂S |
| Molar mass (g mol⁻¹) | 341.87 |
| Symmetry | Orthorhombic |
| Color | White |
| Space group | Amm2 (No. 38) |
| a (Å) | 4.1489(1) |
| b (Å) | 3.9750(9) |
| c (Å) | 12.728(0) |
| Volume (Å³) | 209.9(1) |
| Z | 2 |
| Density (g cm⁻³) | 5.4088 |
| Anisotropic strain (Å⁻²)² | S₄₀₀ = 11.8(9); S₀₄₀ = 8.66(0); |
| | S₀₀₄ = 0.0485(9); S₂₂₀ = 2.82(0); |
| | S₂₀₂ = 0.830(7); S₀₂₂ = 0.636(8); |
| March-Dollase parameter | P_{md} = 0.943(5) |
| (Preferred orientation along <100>) | |
| Structural refinement | |
| Profile reliability factor | Rₚ = 6.38% |
| Weighted profile reliability factor | R_{wp} = 8.73% |
| Bragg reliability factors | R(obs) = R(all) = 1.67% |
| Weighted Bragg profile reliability factors | R_{w}(obs) = R_{w}(all) = 2.29% |
| Goodness of fit | x² = 1.33 |

Atomic positions and isotropic thermal parametersª

| Atom | x | y | z | Uᵢₛₒ (Å²) |
|---|---|---|---|---|
| La1 | 0 | 0 | 0.6442(4) | 0.0054(8) |
| La2 | 0.5 | 0.5 | 0.8379(7) | 0.0040(1) |
| O1 | 0 | 0.5 | 0.7350(1) | 0.001^{b} |
| O2 | 0.5 | 0 | 0.7169(3) | 0.001^{b} |
| S1 | 0 | 0 | 0.9664(7) | 0.0068(4) |

ªSite-occupancy factors of all atoms are fixed to full occupancy.
^{b}These atomic displacement factors are fixed to 0.001.

Scanning Transmission Electron Microscopy (STEM) also support the conclusion that the newly synthesized phase is oA-La₂O₂S. The stacking of 2/∞[La₂O₂] infinite sheets with the fluorine-type (100) slab structure is clearly visible on the High Angle Annular Dark Field (HAADF) STEM image. In contrast, the fluorite-type (111) slabs characteristic of the stable polymorph hP-La₂O₂S could not be found in the experiment STEM image. The EDX spectrum of a nanosized single crystal was, similarly to the EDX analysis of the bulk powder, consistent with the composition of La₂O₂S. The structural arrangement of the new oA-La₂O₂S compound is directly inherited from the one of the La₂O₂S₂. This observation definitely supports the topochemical nature of the deintercalation process. The sulfur deintercalation process does not modify at all the integrity of the 2/∞[La₂O₂] slab but entails a shift of one 2/∞[La₂O₂] layer over two along the % (b+c) direction of the pristine La₂O₂S₂ structure (SG: Cmca). Raman spectroscopy confirmed the complete loss of the sulfur dimers along the topochemical reduction: the band associated to the S—S stretching modes located at 487 and 498 cm⁻ in La₂O₂S₂ have totally disappeared after the deintercalation of one sulfur from La₂O₂S₂ confirming the conclusion made from the XRD pattern that the reaction of hP-La₂O₂S towards oA-La₂O₂S was complete. Finally, the diffuse-reflectance spectra also support the cleavage of (S₂)²⁻ dimers. The absorption thresholds move from 2.50 eV in La₂O₂S₂, a value characteristic of a π*-σ* electronic transition of isolated pairs, to 3.88 eV in oA-La₂O₂S, a value slightly lower than the one observed in the hP-La₂O₂S (4.13 eV). Thus, it was concluded that during the reaction with La₂O₂S₂ with elemental rubidium, the alkali metal activates a redox reaction with (S₂)²⁻ dimers that trigger the fracture of the S—S bonds. However, contrary to Cu⁰ nanoparticles that intercalate into the La₂O₂S₂ host lattice (Angew. Chem. Int. Ed. 57, 13618-13623 (2018)) Rb⁰ leads to the topochemical de-insertion of sulfur to afford the oA-La₂O₂S metastable phase. The choice of reducing agents is the decisive factor on the consequence of the reaction. No reaction occurred when La₂O₂S₂ was treated at 200-300° C. under reducing atmosphere, i.e. 5% H₂/Ar flow. At 350° C. the reduction finally happened, but it ended up with the thermodynamically stable hP-La₂O₂S, where the original fluorite (100) slab was deformed into the fluorite (111) slab. This result highlights the contrast between the common reducing agent such as H₂ and the more powerful reducing agent Rb⁰, which favored even at the same reaction temperature (350° C.) topochemical reduction to oA-La₂O₂S.

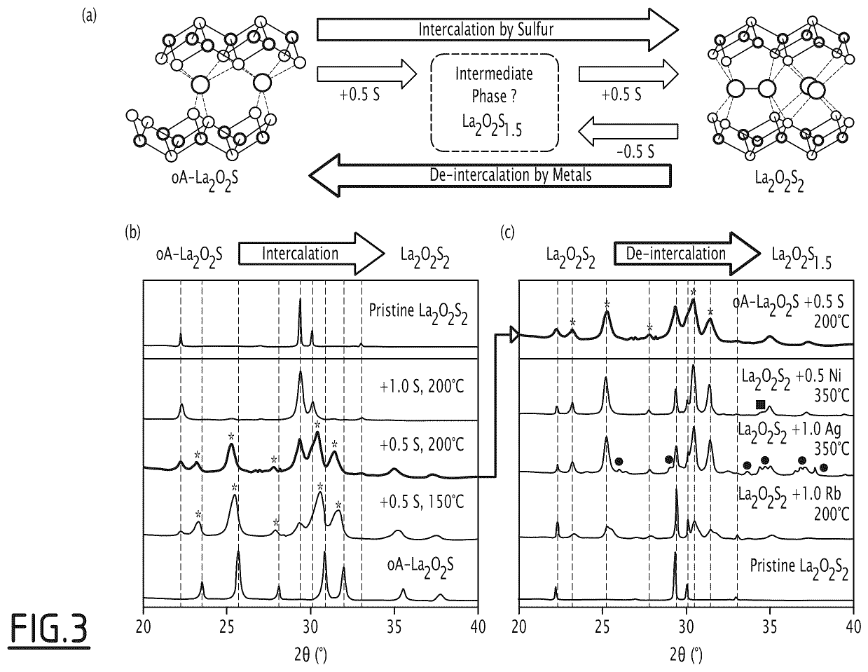

At this stage, it was hypothesized that the topotactic de-intercalation of La₂O₂S₂ may be reversible or not at low temperature. To test this possibility, a portion of oA-La₂O₂S was mixed with one equivalent sulfur and heated at 200° C. (FIG. 3a). The product was analyzed by means of XRD as shown in FIG. 3b. The original La₂O₂S₂ material could be fully recovered with no sub-product confirming the reversible character of the temperature-assisted intercalation/de-intercalation processes based on the formation/rupture of sulfur dimers within the La₂O₂S/La₂O₂S₂ layered oxychalcogenides. To gain more insight about the intercalation of sulfur, the reactivity of oA-La₂O₂S towards only half equivalent of sulfur at low temperature was also tested. The XRD pattern of the product obtained from intercalation of 0.5 S in oA-La₂O₂S at 200° C. (see FIG. 3b) clearly evidences the conversion of oA-La₂O₂S into an unknown intermediate phase along with a small amount of La₂O₂S₂. The XRD pattern of the intermediate phase was similar to that of oA-La₂O₂S but shifted to lower diffraction angles, suggesting the existence of an intercalated oA-La₂O₂Sₓ phase (1<x<2.0). The same XRD pattern was observed in the attempt to de-intercalate 0.5 S from La₂O₂S₂ using 1.0 equiv. of Rb⁰, 1.0 equiv. of Ag and 0.5 equiv. of Ni⁰ (FIG. 3c). Diffraction pattern of oA-La₂O₂S_{1.5} could be refined with the same space group as oA-La₂O₂S (Amm2) and cell parameters of ˜8.4 Å, ˜4.0 Å and ˜12.8 Å without any superstructure peak. This clearly proved the existence of an intermediate phase with a strong reminiscence of the oA-La₂O₂S structure. One of the reasonable assumptions is that this new intermediate phase replaced one half of monoatomic S²⁻ with dimeric (S₂)²⁻ anions retaining the main structural framework of oA-La₂O₂S. This partial dimerization should lead to the expected oA-La₂O₂S_{1.5} composition. Indeed, both intercalation of 0.5 S and de-intercalation of 0.5 S using metal species gave the similar Raman spectra that featured the single intense peak at 413-417 cm⁻ while Raman peaks from oA-La₂O₂S nor La₂O₂S₂ were absent. Since an intense peak around 400-500 cm⁻ is characteristic of S—S stretching mode (Angew. Chem. Int. Ed. Engl. 14, 655-720 (1975)) these Raman spectra support the formation of oA-La₂O₂S_{1.5} through the partial cleavage of S—S bonds.

To solve the crystal structure of this novel phase, precession electron diffraction tomography (PEDT) analyses were performed. This emerging technique can reduce dynamical diffraction effects during data collection and enables complex structures to be solved ab initio using single nanocrystals. PEDT data were therefore collected on several nanocrystals of the novel phase. All data sets were analyzed using the computer programs PETS2.0 (Acta Crystallographica, B75, 512-522 (2019).), Superflip (Journal of Applied Crystallography, 40, 451-456. (2007)) and Jana2006 (Zeitschritt für Kristallographie, 229, 345-352. (2014)). The reconstruction of the reciprocal lattice planes hk0, h0l and 0kl was observed which are consistent with an orthorhombic unit cell a=8.348 Å, b=3.961 Å and c=12.645 Å (V=418.1 Å³) and a non-centrosymmetric space group Amm2. The structure was subsequently solved and refined using the Jana2006 Program on the basis of electron diffraction data. The structural analysis converged with electron Bragg reliability factor R(obs)=10.1%, revealing a layered structure with a composition oA-La₂O₂S_{1.5}. This obtained new structure consists of 2/∞[La₂O₂] fluorine-type (001) infinite slab alternating with sulfur layers containing one third and two thirds of sulfur anions as S²⁻ and (S₂)²⁻ species, respectively. Using this oA-La₂O₂S_{1.5} structure model, both powder XRD patterns from sulfur intercalation and de-intercalation, i.e. from oA-La₂O₂S+0.5 S and La₂O₂S₂+0.5 Ni reaction mixtures (see FIG. 3), were successfully refined. Large strain parameters had to be considered to reach satisfactory fitting. This can be interpreted as the signature of a stacking disorder occurring, as expected, during the intercalation or de-intercalation processes in relation with the 2D structure of the host lattice and possible existence of different stages. The structural analysis was based on data collected on the best crystallized crystals. However, in most of the PEDT data, the stacking faults lead to diffuse scattering features along [001]. The experimental contrast in the HAADF-STEM image asserts the stacking of 2/∞[La₂O₂] fluorine-type (001) infinite slabs. A similar structure was predicted independently by the evolutionary algorithm USPEX for this specific oA-La₂O₂S_{1.5} composition. The structure predicted to be the most stable accorded well with the experimental structure obtained by the PEDT analysis. The 2^{nd} and 3^{rd} most stable structures displayed 1D slabs and 2D hexagonal (fluorine-type (111)) slabs as their [La₂O₂] units and these slabs constituted intergrowth structures with (quasi-)2D arrays of sulfur dimers/atoms. However, none of them could be found in the experiments that were conducted.

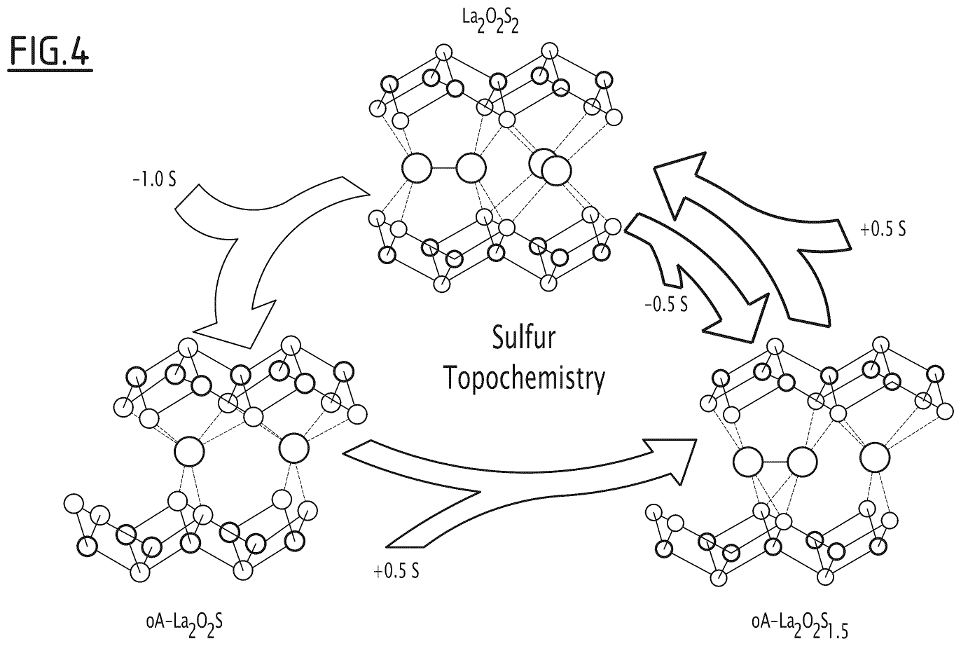

This work demonstrates the de-intercalation and re-intercalation of sulfur in a layered oxychalcogenide compound using an original topochemical approach. Alkali or transition metals may be used as reducing agent to trigger the reduction of the chalcogenide oligomers and breaking the chalcogen-chalcogen bond. In the case of La₂O₂S₂ the low temperature deintercalation of sulfur atoms proceeds in a two steps to form two new metastable phases oA-La₂O₂S_{1.5} and oA-La₂O₂S that retain the layered feature of the precursor. As illustrated in FIG. 4 this is a fully reversible topotactic process as the sulfur atoms may be re-intercalated at low temperature to form back the precursor La₂O₂S₂.

TABLE 2
Summary of crystallographic parameters of La₂O₂Sₓ series (1 ≤ x ≤ 2.0)

| | La₂O₂S₂ | hP-La₂O₂S₂ | oA-La₂O₂S | oA-La₂O₂S_{1.5} |
|---|---|---|---|---|
| Source | Ostorer | Morosin | This study | This study |
| | et al. | et al. | (XRD) | (PEDT) |
| | (XRD) | (XRD) | | |
| Space group | Cmca | P-3m1 | Amm2 | Amm2 |
| a (Å) | 13.215(2) | 4.049(1) | 4.148(9) | 8.348 |
| b (Å) | 5.943(1) | — | 3.975(1) | 3.961 |
| c (Å) | 5.938(1) | 6.939(2) | 12.728(0) | 12.645 |
| S-S distance | 2.103 | 4.049 | 3.975 | 2.011 |
| (Å) | | | | |

Ostero et al Acta Cryst. C46, 1376-1378 (1990)
Morosin et al Angew. Chem. Int. Ed. Engl. 14, 655-720 (1975)

### 1. Synthetic Procedures

The initial precursor La₂O₂S₂ was synthesized following the procedure described in Angew. Chem. Int. Ed. 2018, 57, 13618-13623

oA-La₂O₂S: Topochemical de-intercalation of S²⁻ anions by Rb

Prior to the preparation, all of experimental glassware and utensils were dried in the oven (T=80° C.). Under argon atmosphere, La₂O₂S₂ and Rb (Aldrich, 98+%) were weighed in 1:2 molar ratio and introduced into the silica tube whose bottom was protected by carbon coating. All these preparations were done under argon atmosphere. Then the pyrex tube was evacuated (˜10⁻³ torr) and sealed. The sealed mixture was heated to 200° C. at a rate of 20° C. h⁻¹ and annealed for 2 h. Finally the sealed mixture was gradually cooled in a furnace to give the pale greyish-blue powder. The surplus Rb deposited on the opposite side of the silica tube. The silica tube was opened under argon atmosphere and all the content was quenched with the excess amount of ethanol (Attention: under the ambient atmosphere, Rb ignites upon the contact with ethanol). The colorless precipitate was contaminated by the tiny flakes of carbon, which were separated by repetitive decantation with mechanical agitation. The precipitate was then washed with ethanol, water, and acetone, followed by dryness in vacuo to afford the colorless powder of oA-La₂O₂S. The product was stable under the ambient atmosphere. The same reaction performed at 350° C. also gave the identical results: pure oA-La₂O₂S without any trace of hP-La₂O₂S nor any other impurities.

Intercalation of Sulfur Anions into oA-La₂O₂S

The colorless powder of oA-La₂O₂S (ca. 200 mg) was combined with S flakes (Aldrich, 99.99+%) in oA-La₂O₂S: S=1: 0.5 molar ratio and ground on an agate mortar under argon atmosphere. Then the mixture was pelletized and sealed in an evacuated (˜10⁻³ torr) silica tube. The sealed mixture was heated to 150-200° C. at a rate of 100° C. h⁻¹ and annealed for 4-48 h (See FIG. 3b for the result), followed by gradual cooling in a furnace to afford the pale yellow pellet. When the sulfur was not completely consumed, the residual sulfur was deposited on the opposite side of the silica tube. To complete the intercalation, the obtained pellet was ground with additional 0.5 equiv. of S under argon atmosphere. The mixture was again subject to the thermal treatment at 200° C. in the evacuated silica tube. After 160 h of annealing, the mixture was fully converted into the pale yellow pellet of the pure La₂O₂S₂.

oA-La₄04S₃: General Procedure for topochemical de-intercalation of S²⁻ anions by various metals

The detailed synthetic conditions (i.e. Stoichiometry, duration of annealing, forms of metal sources) for respective metal species were noted below. To 1.0 equiv. of La₂O₂S₂ (ca. 150-250 mg), 0.5-2.0 equiv. of metal elements was added and ground together under argon atmosphere until the powder becomes greyish and sticky on an agate mortar. Then the mixture was pelletized and sealed in an evacuated (˜10⁻³ torr) silica tube. The sealed mixture was heated to 350° C. at a rate of 300° C. h⁻¹ and annealed for 2-4 h. Finally the sealed mixture was gradually cooled in a furnace to afford the mixture containing oA-La₄O₄S₃ (See FIG. 3c for its XRD).

The reaction with Ag:
1.0 equiv. of Ag powder (Aldrich, 2-3.5 μm, ≥299.9%) was added. Annealing: 4 h Little excess (−1.1 equiv.) of Ag nor prolonged/repeated thermal treatments did not lead further consumption of La₂O₂S₂.
The reaction with Ni:
0.5 equiv. of Ni nanopowder (Aldrich, <100 nm, 99%) was added. Annealing: 4 h Prolonged and repeated thermal treatments did not improve the yield of oA-La₄O₄S₃ but ended up with the partial decomposition into hP-La₂O₂S

1. An electroactive material for electrochemical cell electrode, said electroactive material comprising a chalcogen oligomer, wherein said electroactive material reversibly deintercalates an anion of said chalcogen by reduction and reintercalates said anion by oxidation, while maintaining its overall structure.

2. The electroactive material of claim 1 wherein said chalcogen anion is sulfur or an oligomer thereof of formula (III):
(Sₙ)^{x-} (III)
where n and x are Integers, such that x equals to 1 or 2 and n is comprised between 1 and 6.

3. The electroactive material according to claim 1 wherein said chalcogen anion is S²⁻.

4. The electroactive material according to claim 1 which is chosen from La₂O₂S₂, SrS₂, SrS₃, BaS₂, BaS₃, Ba₂S₂F₂, FeS₂, NIS₂, CoS₂, MnS₂, TIS₃, VS₄, PbS₂, BIS₂.

5. The electroactive material according to claim 1 wherein said active material is La₂O₂S₂, which reversibly deintercalates and reintercalates S²⁻ according to the following reaction:
La₂O₂S₂+2e⁻⇄oA-La₂O₂S+S²⁻
where oA designates the centered orthorhombic crystalline form.

6. The electroactive material according to claim 1 wherein said active material is a material of formula (I):
oA-La₂O₂S (I)
where oA designates the centered orthorombic crystalline form.

7. The electroactive material according to claim 1 wherein said active material is a material of formula (II):
oA-La₂O₂S_{1.5} (II)
where oA designates the centered orthorhombic crystalline form.

8. A positive electrode comprising the electroactive material according to claim 1.

9. The positive electrode according to claim 8 comprising:
a current; and
a coating layer comprising said electroactive material.

10. The positive electrode according to claim 9, wherein the current collector is an aluminum sheet.

11. An electrochemical cell comprising:
a positive electrode as defined in claim 8;
a negative electrode; and
an electrolyte layer sandwiched between the positive and the negative electrodes, wherein the electrolyte is a solid electrolyte comprising as conducting ion the chalcogen anion of the chalcogen oligomer of said electroactive material.

12. A battery comprising a plurality of electrochemical cells as defined in claim 11, wherein said electrochemical cells are electrically connected.
